(19) United States
(12) Patent Application Publication
(10) Pub. No.: US 2026/0093085 A1
(43) Pub. Date: Apr. 2, 2026

(54) LENS BARREL

(71) Applicant: Panasonic Intellectual Property Management Co., Ltd., Osaka (JP)

(72) Inventors: Takahiro MATSUKAWA, Osaka (JP); Masayuki SHODAI, Osaka (JP); Masayuki NAGAHARA, Osaka (JP)

(73) Assignee: Panasonic Intellectual Property Management Co., Ltd., Osaka (JP)

(21) Appl. No.: 19/334,802

(22) Filed: Sep. 20, 2025

(30) Foreign Application Priority Data
Sep. 27, 2024 (JP) 2024-168188

(51) Int. Cl. G02B 7/02; G02B 27/64

(52) U.S. Cl. CPC G02B 7/021; G02B 27/646

(57) ABSTRACT

A lens barrel 10 is provided with a lens unit holding frame 27, a lens unit 25, an adjusting screw 24, and an anti-sinking member 23. The lens unit 25 is attached to the lens unit holding frame 27. The adjusting screw 24 restricts movement of the lens unit 25 in a direction away from the lens unit holding frame 27 in the optical axis direction by means of a screw head 24b, and adjusts the tilt of the lens unit 25 with respect to the lens unit holding frame 27. The anti-sinking member 23 is fixed to the lens unit 25, and is provided at a position where it makes contact with the screw head 24b of the adjusting screw 24 in the optical axis direction.

### CROSS-REFERENCE TO RELATED APPLICATIONS

This application claims priority to Japanese Patent Application No. 2024-168188 filed on September 27, 2024. The entire disclosure of Japanese Patent Application No. 2024-168188 is hereby incorporated herein by reference.

### BACKGROUND

### Technical Field

The present disclosure relates to a lens barrel that is attached to a camera body, for example.

### Description of the Related Art

In recent years, in lens barrels that include a lens frame for holding a lens, a configuration has been employed in which the tilt of the lens frame with respect to a frame body that serves as a reference is adjusted in order to adjust the tilt of the optical axis of the lens.

For example, Patent Literature 1 discloses a lens barrel that is provided with a frame that holds an optical element, a cylindrical frame holding member that holds the frame, and an adjustment unit that adjusts the tilt of the frame relative to a specific axis of the frame holding member so that the optical axis of the optical element will be parallel to the specific axis of the frame holding member.

With this lens barrel, the adjustment unit includes an adjusting screw having a screw shaft with a screw head and a male threaded section, a female threaded section that is formed in the frame holding member so as to extend in a direction parallel to the optical axis and so as to be able to be mesh with the male threaded section, a through-hole that is made in the frame in a direction parallel to the optical axis, a contact section that is located around the through-hole and makes contact with the screw head when the screw shaft is inserted into the through-hole, and a hole that is formed in the frame holding member continuously with the female threaded section. The screw shaft has a mating section that extends from the male threaded section toward the distal end of the adjusting screw and mates with the hole.

### CITATION LIST

### PATENT LITERATURE

Patent Literature 1: JP-A 2018-49049

### SUMMARY

### PROBLEM TO BE SOLVED BY THE INVENTION

However, the following problem is encountered with the above-mentioned conventional lens barrel.

With the lens barrel disclosed in the above publication, when the lens frame is subjected to an external force in the optical axis direction, the position of the lens frame, which is restricted by the head of the adjusting screw, may change due to the contraction of the biasing member, and this can have an adverse effect on resolution and other kinds of optical performance.

It is an object of the present disclosure to provide a lens barrel with which the position of a lens frame in the optical axis direction is prevented from changing even when the lens frame is subjected to an external force in the optical axis direction.

### MEANS FOR SOLVING PROBLEM

The lens barrel disclosed herein is provided with a substantially cylindrical reference frame, a lens frame, a fastening member, and an anti-sinking member. The lens frame holds a lens and is attached to the reference frame. The fastening member has a threaded portion that threads into the reference frame and a screw head provided on the opposite side from the threaded portion, in which the screw head restricts movement of the lens frame in a direction away from the reference frame in the optical axis direction, and adjusts the tilt of the lens frame relative to the reference frame by changing the threaded length of the threaded portion. The anti-sinking member is fixed to the lens frame and is provided at a position that makes contact with the screw head of the fastening member in the optical axis direction.

### EFFECTS

With the lens barrel disclosed herein, even if the lens frame is subjected to an external force in the optical axis direction, the position of the lens frame in the optical axis direction can be prevented from changing.

### BRIEF DESCRIPTION OF THE DRAWINGS

FIG. 1 is an overall oblique view of the configuration of the lens barrel according to an embodiment of the present disclosure;

FIG. 2A is an external oblique view showing a state in which the lens barrel in FIG. 1 is in the wide-angle position;

FIG. 2B is an external oblique view showing a state in which the lens barrel in FIG. 1 is in the telephoto position;

FIG. 3 is an exploded oblique view of the components that constitute the lens barrel in FIG. 1;

FIG. 4 is a cross-sectional view of the lens barrel in FIG. 1;

FIG. 5A is a cross-sectional view showing a state in which the lens barrel in FIG. 1 is in the wide-angle position;

FIG. 5B is a cross-sectional view showing a state in which the lens barrel in FIG. 1 is in the telephoto position;

FIG. 6 is an exploded oblique view of the configuration of a first lens group unit included in the lens barrel in FIG. 1;

FIG. 7 is a front view of the first lens group unit in FIG. 6 in a state in which an exterior ring has been removed, as viewed from the subject side;

FIG. 8 is a cross-sectional view along the A–A line in FIG. 7;

FIG. 9 is a cross-sectional view from which the background portion in FIG. 8 has been removed;

FIG. 10A is a cross-sectional view of the first lens group unit shown in FIG. 7 along the B–B line;

FIG. 10B is a cross-sectional view in which the background portion of FIG. 10A has been removed;

FIG. 11 is an exploded oblique view of the configuration of a first lens group unit included in the lens barrel according to another embodiment of the present disclosure;

FIG. 12 is a front view of the first lens group unit in FIG. 11 in a state in which the exterior ring has been removed, as viewed from the subject side;

FIG. 13A is a detail view of the components around a through-hole formed in the lens frame in the portion X in FIG. 12;

FIG. 13B is a detail view showing a state in which an adjusting screw has been inserted into the through-hole formed in the lens frame in FIG. 13A;

FIG. 13C is a detail view showing a state in which the lens frame has been rotated in the direction of the arrow in the drawing from the state shown in FIG. 13B, so that the restricting portion has been engaged with part of the adjusting screw;

FIG. 14A is a cross-sectional view corresponding to FIG. 13B, showing a state in which the adjusting screw has been inserted into the through-hole formed in the lens frame; and

FIG. 14B corresponds to FIG. 13C and is a detail view showing a state in which the lens frame has been rotated in the direction of the arrow in the drawing from the state shown in FIG. 14A, so that the restricting portion has been engaged with part of the adjusting screw.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### EMBODIMENT 1

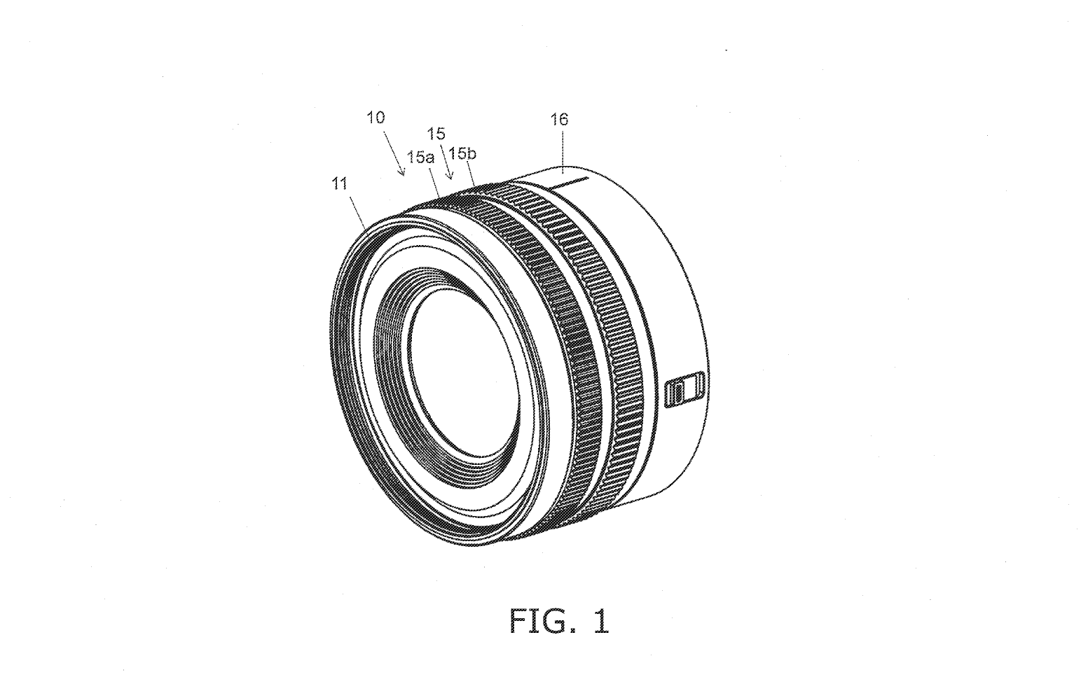

The lens barrel according to an embodiment of the present disclosure will now be described with reference to FIGS. 1 to 10B.

### (1) Overall Configuration of Lens Barrel 10

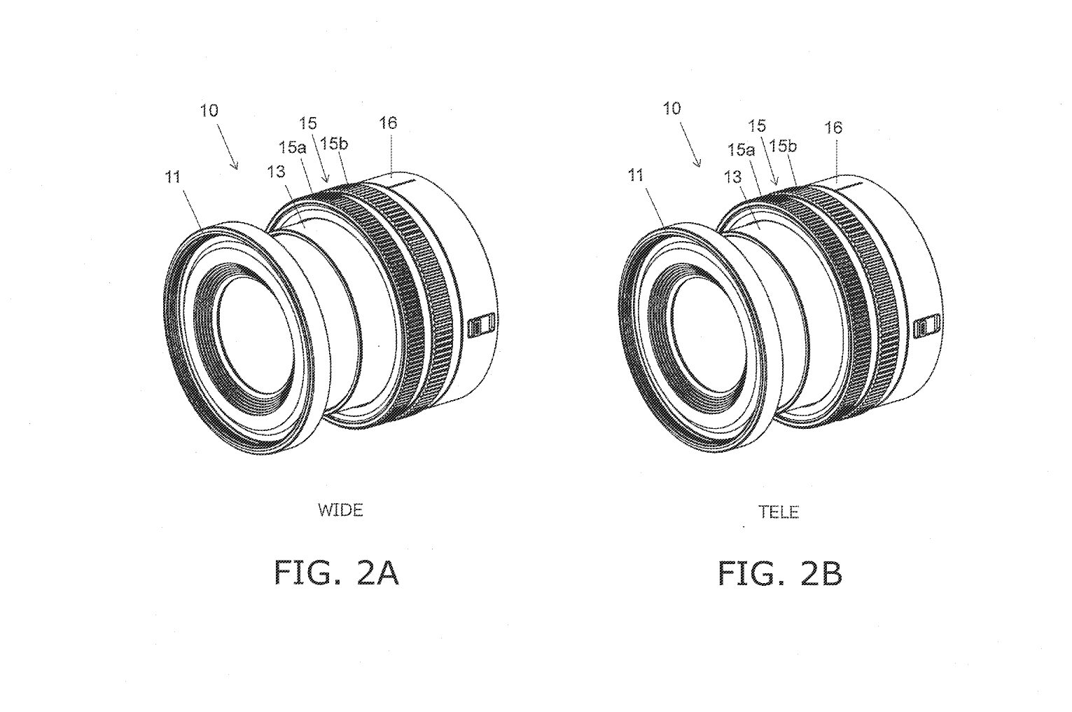

As shown in FIG. 1, the lens barrel 10 according to this embodiment is detachably attached to a camera body (not shown), and captures an image of a subject. The lens barrel 10 performs zooming by moving a built-in optical system (a plurality of lenses L1 to L8) between the wide-angle side (WIDE side position) shown in FIG. 2A and the telephoto side (TELE side position) shown in FIG. 2B.

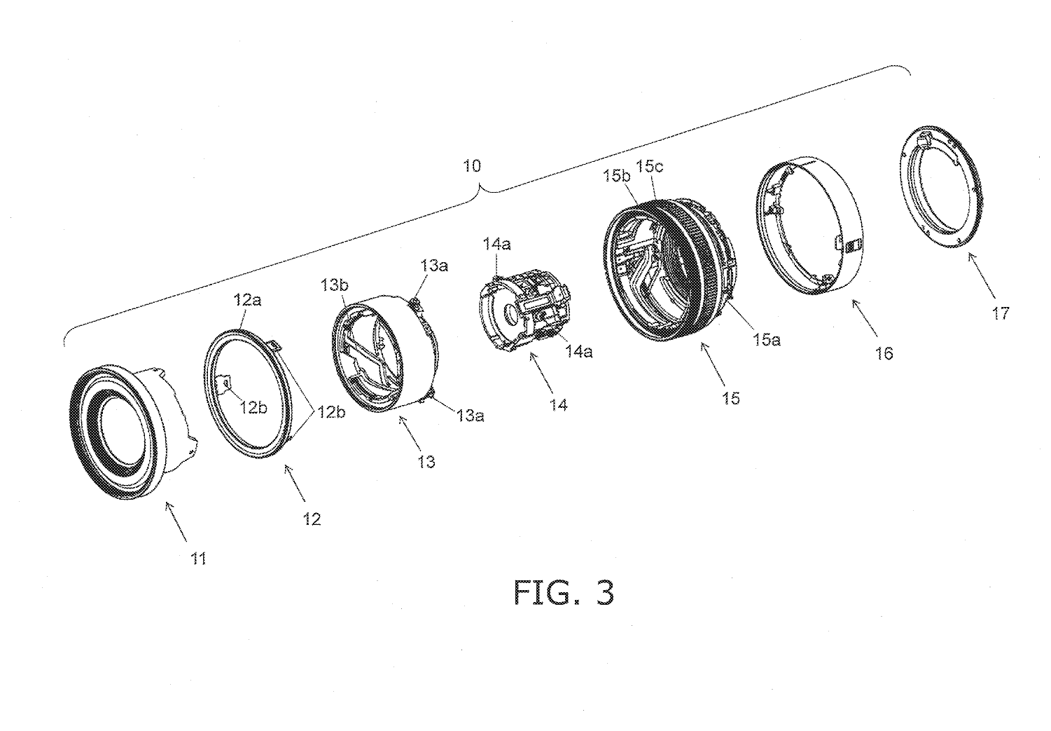

As shown in FIG. 3, the lens barrel 10 includes a first lens group unit 11, a front frame unit 12, a cam/rectilinear unit 13, a second and third lens group unit 14, an exterior unit 15, a rear frame unit 16, and a lens mount 17.

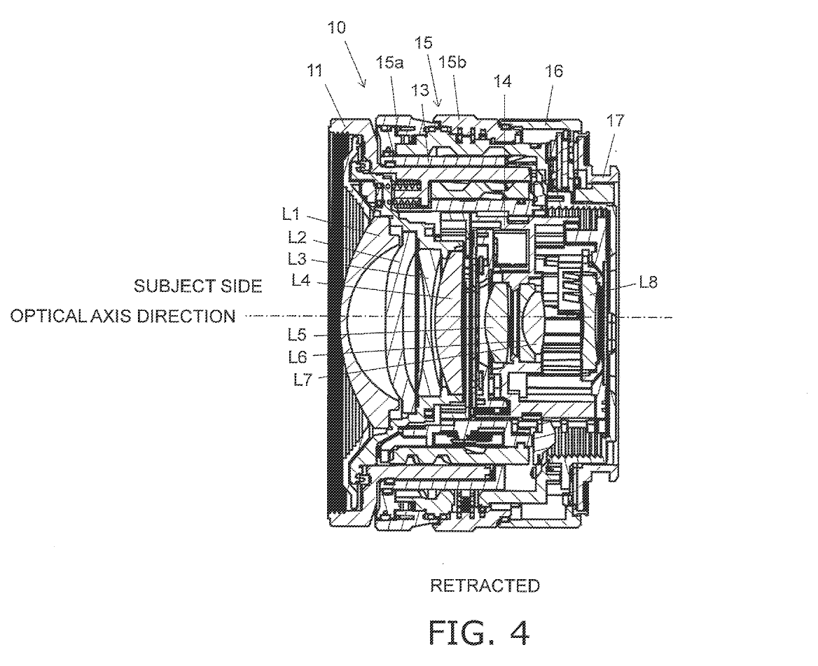

As shown in FIG. 3, the first lens group unit 11 is disposed closest to the subject in the optical axis direction among all of the members constituting the lens barrel 10. As shown in FIG. 4, the first lens group unit 11 holds lenses the L1 to L4 on the inner peripheral side of its approximately cylindrical shape.

The detailed configuration of the first lens group unit 11 will be described below.

As shown in FIG. 3, the front frame unit 12 has a substantially annular main body portion 12a, and a latched portion 12b that engages with the inner peripheral surface of the exterior unit 15 that envelops the cam/rectilinear unit 13 and the second and third lens group unit.

As shown in FIG. 3, the cam/rectilinear unit 13 is a substantially cylindrical member enveloped on the inner peripheral surface side of the exterior unit 15, and has three cam followers 13a protruding radially outward from the outer peripheral surface, and a cam groove 13b formed on the inner peripheral surface side.

The three cam followers 13a engage with cam grooves formed on the inner peripheral surface of the exterior unit 15, and move along the rectilinear grooves formed in the inner peripheral surface of the exterior unit 15 when the focus ring 15b and zoom ring 15c of the exterior unit 15 are turned.

As shown in FIG. 3, the second and third lens group unit 14 is a substantially cylindrical member enveloped on the inner peripheral surface side of the exterior unit 15, and holds the lenses L5 to L8 as shown in FIG. 4. The second and third lens group unit 14 has three cam followers 14a that protrude radially outward from its outer peripheral surface.

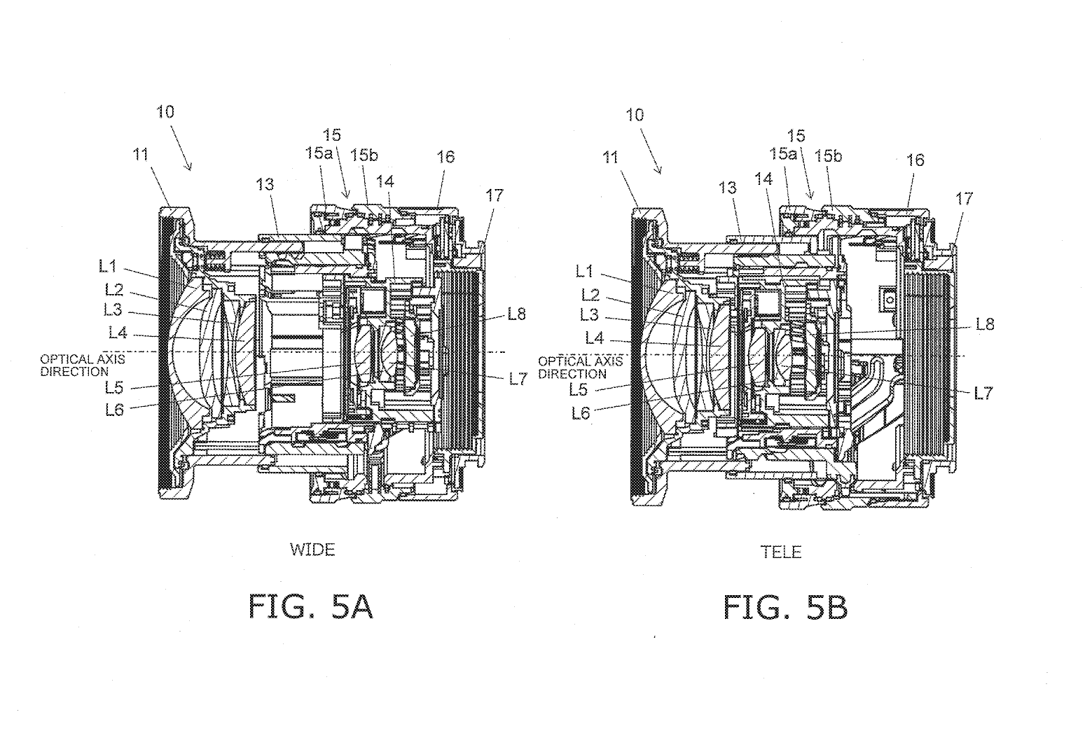

The three cam followers 14a engage with cam grooves 13b formed in the inner peripheral surface of the cam/rectilinear unit 13. When the focus ring 15b and the zoom ring 15c of the exterior unit 15 are turned, the cam followers 14a move along the cam grooves 13b, causing the second and third lens group unit 14 to move back and forth in the optical axis direction between the WIDE position shown in FIG. 5A and the TELE position shown in FIG. 5B.

As shown in FIG. 3, the exterior unit 15 has a substantially cylindrical main body portion 15a that constitutes the exterior of the lens barrel 10, and a focus ring 15b and a zoom ring 15c that are attached to the outer peripheral surface of the main body portion 15a in a state of being rotatable around the optical axis.

As shown in FIG. 3, the rear frame unit 16 is a substantially cylindrical member, and is attached so as to cover the outer peripheral surface of the rear end side of the exterior unit 15,

As shown in FIG. 3, the lens mount 17 is a coupling member for mounting the lens barrel 10 to a camera body (not shown), and is attached to the end of the exterior unit 15 on the opposite side from the subject in the optical axis direction.

### (2) Configuration of First Lens Group Unit 11

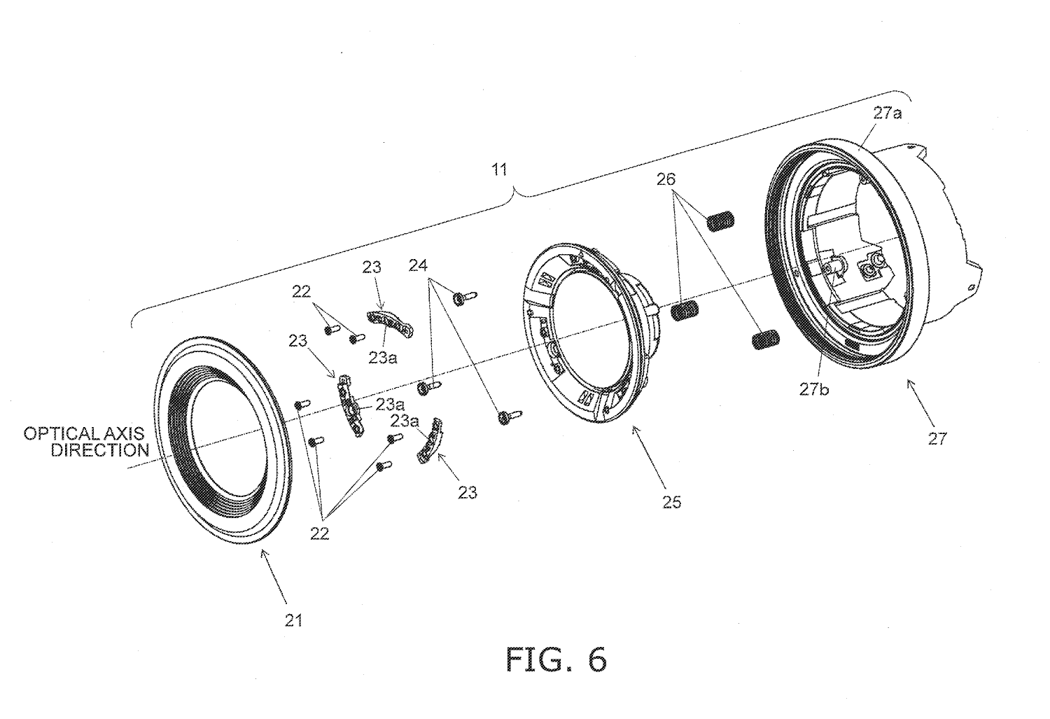

As shown in FIG. 6, the first lens group unit 11 includes an exterior ring 21, fixing screws 22, anti-sinking members 23, an adjusting screw (fastening member) 24, a lens unit (lens frame) 25, an adjustment spring (biasing member) 26, and a lens unit holding frame (reference frame) 27.

As shown in FIG. 6, the exterior ring 21 is a substantially disk-shaped member provided closest to the subject side of the first lens group unit 11 in the optical axis direction, and is attached to the inner peripheral surface of the lens unit holding frame 27 so as to cover the substantially disk-shaped surface of the lens unit 25 on the subject side.

This covers the anti-sinking members 23 and so forth (discussed below) so that they cannot be seen from the subject side.

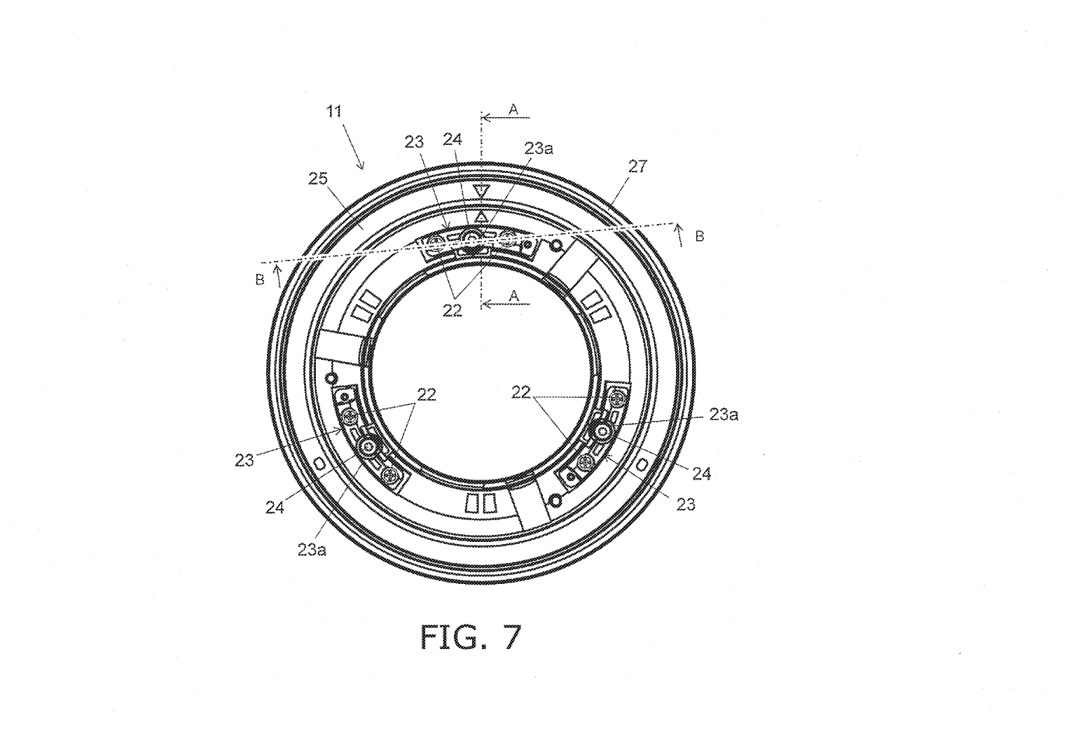

As shown in FIG. 7, two fixing screws 22 are provided for each anti-sinking member 23 in order to fix the anti-sinking member 23 to the lens unit 25.

Consequently, the three anti-sinking members 23 are each fixed to the substantially disk-shaped surface of the lens unit 25 on the subject side in the optical axis direction, and are integrated with the lens unit 25.

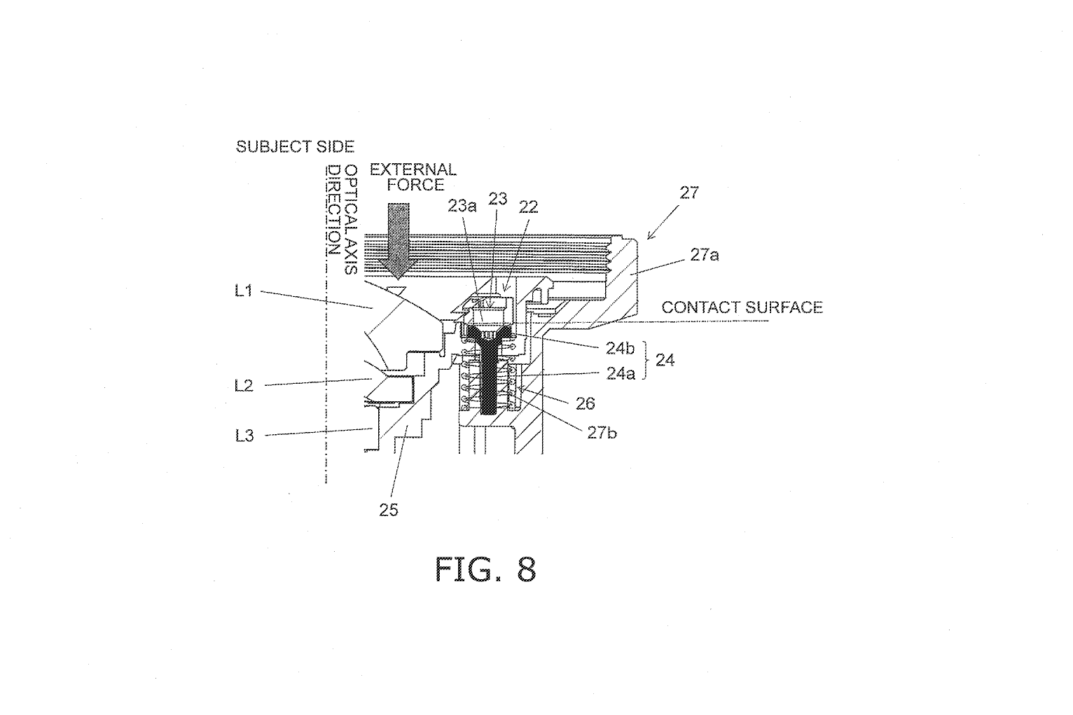

As shown in FIG. 6, the anti-sinking members 23 are plate-shaped members fixed to the substantially disc-shaped surface of the lens unit 25, and are provided as separate members from the lens unit 25. As shown in FIG. 7, the anti-sinking members 23 are provided at positions opposite the adjusting screws 24 provided at substantially equal angular intervals (approximately 120 degrees) in the circumferential direction centered on the optical axis. The anti-sinking members 23 are disposed so as to cover the screw heads 24b of the adjusting screws 24, as shown in FIG. 8.

As shown in FIGS. 7 and 8, the anti-sinking members 23 each have a hole 23a into which is inserted a tool (such as a screwdriver) for adjusting the tilt of the lens unit 25.

This allows the tilt of the lens unit 25 with respect to the lens unit holding frame 27 to be adjusted by turning the adjusting screws 24 with a tilt adjustment tool (such as a screwdriver) that is inserted into the hole 23a.

Three of the adjusting screws (fastening members) 24 are provided at approximately equal angular intervals (about 120 degrees) in the circumferential direction centered on the optical axis in order to adjust the tilt of the lens unit 25 relative to the lens unit holding frame 27.

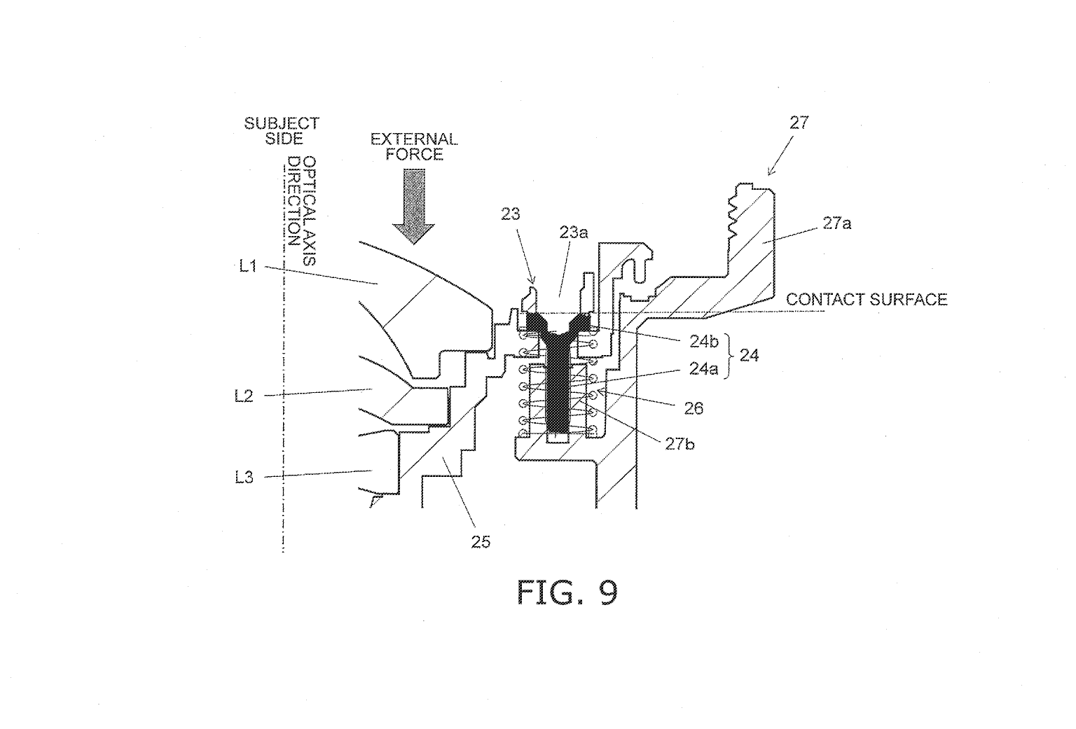

As shown in FIGS. 8 and 9, each adjusting screw 24 has a threaded portion 24a having male threads formed around its outer peripheral surface, and a screw head 24b provided on the opposite side from the threaded portion 24a.

The threaded portion 24a is threaded into a screw hole provided to the lens unit holding frame 27 as shown in FIGS. 8 and 9.

As shown in FIGS. 8 and 9, the screw head 24b has a larger outside diameter than the threaded portion 24a, and is disposed on the subject side in the optical axis direction. The surface of the screw head 24b on the subject side in the optical axis direction makes contact with an anti-sinking member 23 fixed to the lens unit 25.

As shown in FIG. 4, etc., the lens unit (lens frame) 25 is a lens frame that holds the lenses L1 to L4, and as shown in FIGS. 8 and 9, is attached to the lens unit holding frame 27 via an adjustment spring 26 and the adjusting screws 24. More precisely, the lens unit 25 is attached by the adjusting screws 24 to the lens unit holding frame 27 in a state of being able to pivot, with the adjustment spring 26 inserted between the lens unit 25 and the lens unit holding frame 27.

As shown in FIGS. 6 and 7, the adjustment spring (biasing member) 26 is provided between the lens unit holding frame 27 and the lens unit 25, and applies a biasing force that biases the lens unit 25 in the optical axis direction toward the lens unit holding frame 27. The adjustment springs 26 are members formed in a spiral shape that applies a biasing force in the optical axis direction, and three of these are provided together with the adjusting screws 24 in the circumferential direction around the optical axis.

Here, as shown in FIGS. 8 and 9, the adjustment springs 26 are disposed with both ends sandwiched between the lens unit holding frame 27 and the screw heads 24b of the adjusting screws 24. Accordingly, the threaded portions 24a of the adjusting screws 24 expand and contract according to the length by which the screws are threaded into the lens unit holding frame 27.

Consequently, the tilt of the lens unit 25 with respect to the lens unit holding frame 27 can be adjusted by turning the adjusting screws 24 that support the lens unit holding frame 27 at three points to change the screw-in length into the lens unit holding frame 27. This allows the orientation of the optical axis of the lenses L1 to L4 held by the lens unit 25 to be aligned with the imaging element provided on the camera body (not shown) side.

However, the adjustment springs 26 are used as auxiliary components, and serve to reduce the effect of manufacturing error. A specific configuration for fixing the lens unit holding frame 27 (anti-sinking members 23) will be discussed below.

As shown in FIG. 6, the lens unit holding frame (reference frame) 27 is a substantially cylindrical member located on the opposite side from the subject in the optical axis direction. The lens unit 25 is attached to the lens unit holding frame 27 from the subject side in the optical axis direction, and serves as a reference frame in adjusting the tilt of the lens unit 25.

As shown in FIG. 6, the lens unit holding frame 27 has a substantially cylindrical main body portion 27a and substantially cylindrical screw receiving portions 27b that are provided on the inner peripheral surface side of the main body portion 27a and extend in the optical axis direction.

The screw receiving portions 27b are provided at three equal angular intervals (approximately 120 degrees) on the inner peripheral surface of the substantially cylindrical main body portion 27a. The screw receiving portions 27b have a screw hole (female thread) formed along the central axis of the substantially cylindrical portion.

As a result, the threaded portions 24a of the three adjusting screws 24 are threaded into the screw holes formed in the screw receiving portions 27b of the lens unit holding frame 27.

Furthermore, as shown in FIGS. 8 and 9, the adjustment springs 26 are attached so as to be wound around the outer periphery of the substantially cylindrical screw receiving portions 27b.

Consequently, the adjustment springs 26 are positioned along the optical axis direction, with the end on the subject side held by the screw heads 24b of the adjusting screws 24, and the end on the opposite from the subject held by the base portion of the screw receiving portions 27b of the lens unit holding frame 27.

The lens barrel 10 in this embodiment may be configured so that the lens unit 25 is fixed to the lens unit holding frame 27 without the use of the adjustment springs 26.

With the lens barrel 10 of this embodiment, the anti-sinking members 23 are disposed so as to cover the screw heads 24b of the adjusting screws 24, as shown in FIG. 8.

At this point, the surface of the lens unit 25 on the opposite side from the subject in the optical axis direction is in contact with the screw heads 24b of the adjusting screws 24. That is, the screw heads 24b of the adjusting screws 24, whose threaded portions 24a are threaded into the lens unit holding frame 27, are covered by the anti-sinking members 23 in a state of contact from the subject side.

### ANTI-SINKING MECHANISM

As described above, with the lens barrel 10 of this embodiment, the lens unit 25 is attached to the lens unit holding frame 27 via the three sets of adjusting screws 24 and adjustment springs 26. The lens barrel 10 is equipped with a tilt adjustment mechanism for adjusting the tilt of the lens unit 25 with respect to the lens unit holding frame 27 by turning the adjusting screws 24 to change the screw-in length of the adjusting screws 24 into the lens unit holding frame 27.

In a configuration such as this equipped with a tilt adjustment mechanism, movement of the lens unit 25 toward the subject in the optical axis direction relative to the lens unit holding frame 27 is restricted by the screw heads 24b of the adjusting screws 24. Meanwhile, the lens unit 25 can be moved with respect to the lens unit holding frame 27 by contracting the adjustment springs 26 on the opposite side from the subject in the optical axis direction.

Here, in the case of a conventional configuration in which no anti-sinking members 23 are provided, if an external force is exerted on the lens unit 25 from the subject side in the optical axis direction, the lens unit 25 will move (sink) to the opposite side from the subject in the optical axis direction while the adjustment springs 26 contract. For this reason, there is the risk that the tilt of the lens unit 25 with respect to the lens unit holding frame 27 adjusted with the adjusting screws 24 will change, and this may adversely affect the resolution and other such aspects of optical performance.

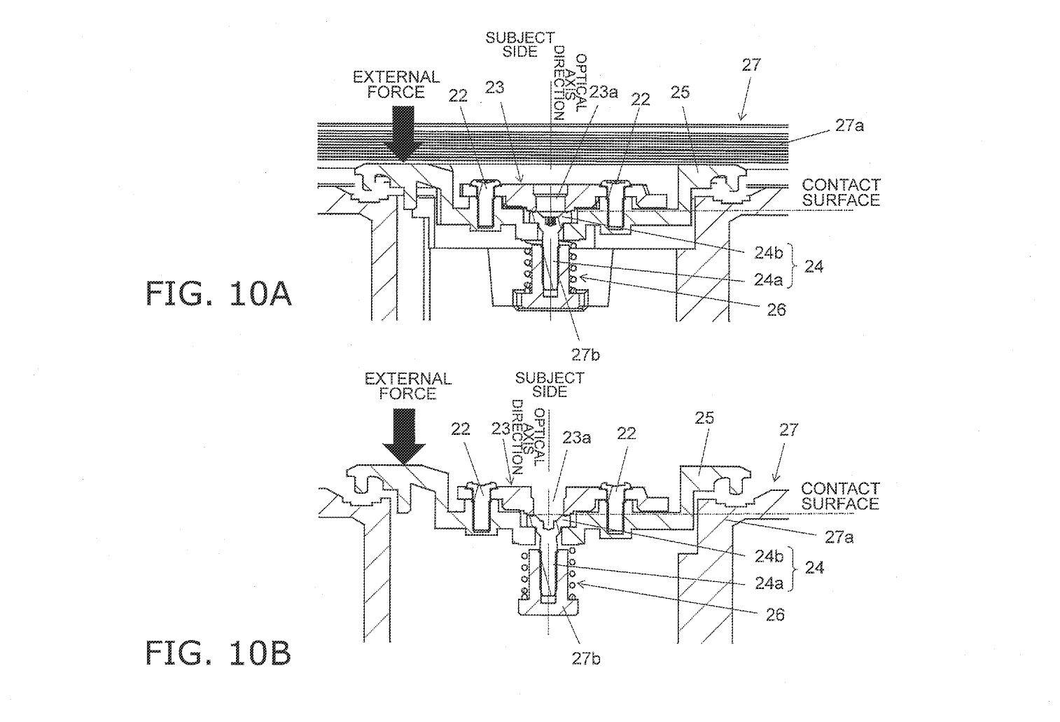

In view of this, with the lens barrel 10 of this embodiment, as shown in FIGS. 10A and 10B, the anti-sinking members 23 are fixed to the surface of the lens unit 25 on the subject side in the optical axis direction, and is integrated with the lens unit 25. The surfaces of the anti-sinking members 23 on the opposite side from the subject in the optical axis direction make contact with the screw heads 24b of the adjusting screws 24 that are threaded into and integrated with the lens unit holding frame 27, as shown in FIGS. 10A and 10B.

Therefore, the anti-sinking members 23 function as stoppers for preventing the lens unit 25 from moving to the opposite side from the subject in the optical axis direction, so the lens unit 25 will not move and sink to the opposite side from the subject in the optical axis direction.

### MAIN FEATURES

The lens barrel 10 of this embodiment includes the substantially cylindrical lens unit holding frame 27, the lens unit 25, the adjusting screws 24, and the anti-sinking members 23. The lens unit 25 holds the lenses L1 to L4 and is attached to the lens unit holding frame 27. The adjusting screws 24 each have a threaded portion 24a that threads into the lens unit holding frame 27, and a screw head 24b that is provided on the opposite side from the threaded portion 24a, and the screw heads 24b restrict the movement of the lens unit 25 in the direction away from the lens unit holding frame 27 in the optical axis direction, and the tilt of the lens unit 25 with respect to the lens unit holding frame 27 is adjusted by changing the screw-in length of the threaded portion 24a. The anti-sinking members 23 are fixed to the lens unit 25 and are provided at positions that make contact with the screw heads 24b of the adjusting screws 24 in the optical axis direction.

Consequently, when an external force is exerted on the lens unit 25 from the subject side in the optical axis direction, the anti-sinking members 23 integrated with the lens unit 25 make contact with the screw heads 24b, so that the anti-sinking members 23 function as stoppers. Therefore, the lens unit 25 is maintained in its position, without moving so as to sink to the opposite side from the subject in the optical axis direction.

As a result, even if the lens unit 25 is subjected to an external force in the optical axis direction, the position of the lens unit 25 in the optical axis direction can be prevented from changing.

### OTHER EMBODIMENTS

An embodiment of the present disclosure was given above, but the present disclosure is not limited to or by the above embodiment, and various modifications are possible without departing from the gist of the disclosure.

(A)

In the above embodiment, an example was given in which the anti-sinking members 23 were provided as separate members from the lens unit 25, and were fixed to the lens unit 25 by the fixing screws 22. However, the present disclosure is not limited to this.

For example, the anti-sinking members may be integrated with the lens unit.

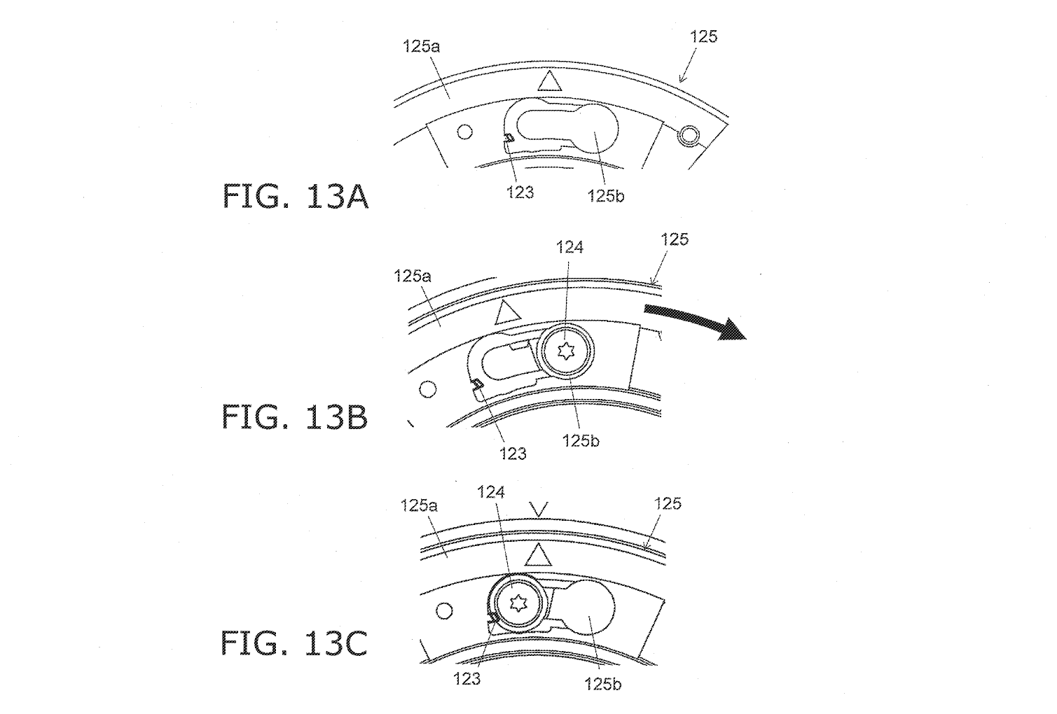

More specifically, restricting portions 123 provided as anti-sinking members may be integrally molded with the lens unit (lens frame) 125 (see FIG. 13A, etc.).

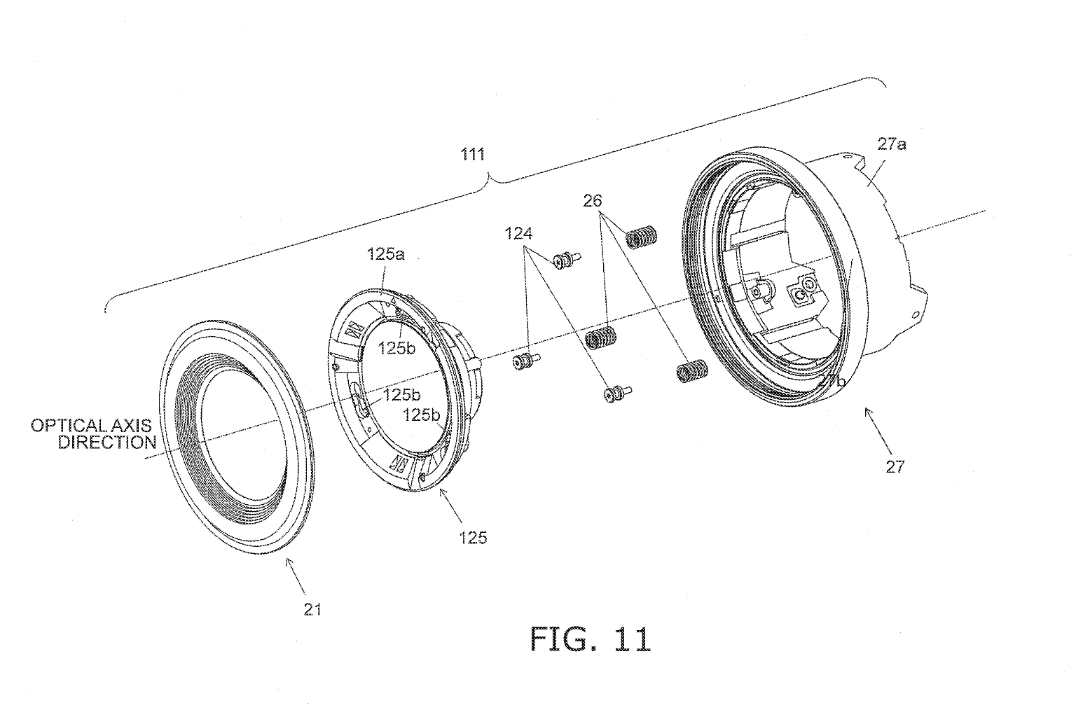

In this case, as shown in FIG. 11, the configuration of a first lens group unit 111 can be one in which there is no the need for the anti-sinking members 23 and the fixing screws 22 for fixing these, in contrast to the configuration of the first lens group unit 11 described in the above embodiment.

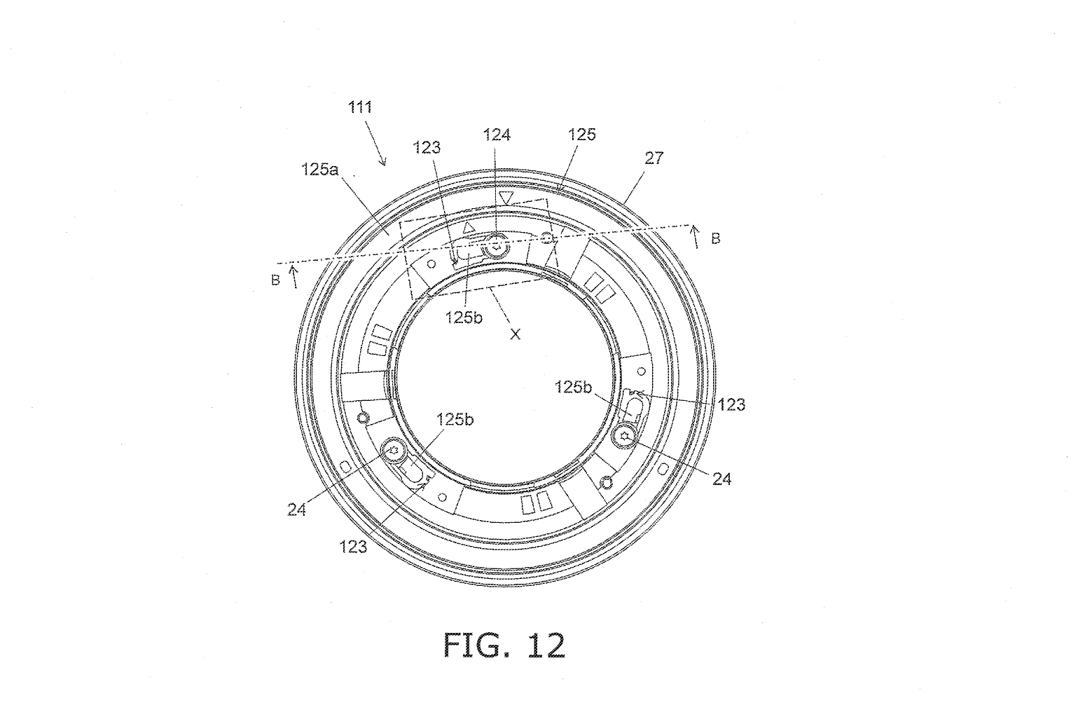

As shown in FIGS. 11 and 12, the first lens group unit 111 includes the exterior ring 21, adjusting screws (fastening members) 124, a lens unit (lens frame) 125, adjustment springs 26, and a lens unit holding frame 27.

The lens unit 125 has a substantially circular main body portion 125a, through-holes 125b into which the adjusting screws 24 are inserted in the optical axis direction and which has an opening formed along the circumferential direction, and restricting portions (anti-sinking members) 123.

As shown in FIG. 13A, the restricting portions (anti-sinking members) 123 are provided near through-holes 125b formed in the main body portion 125a of the lens unit 125, and are provided so as to protrude in the circumferential direction centered on the optical axis. As shown in FIG. 13B, when the lens unit 125 is rotated in the circumferential direction (the direction of the arrow in FIG. 13B) with the adjusting screws 24 inserted in the through-holes 125b, the restricting portions 123 engage with a part (recesses 124c) of the adjusting screws 124, as shown in FIG. 13C, to restrict the movement of the adjusting screws 124 in the optical axis direction.

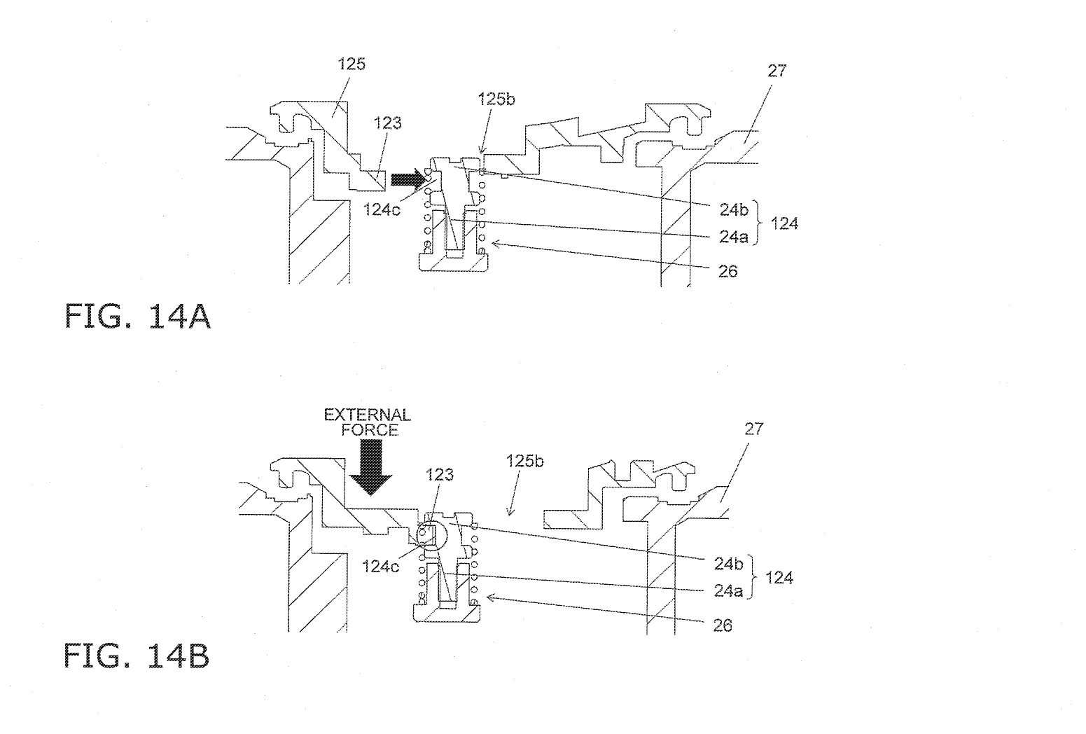

As shown in FIG. 14A, when the adjusting screws (fastening members) 124 are inserted into the through-holes 125b of the lens unit 125, the adjustment springs 26 are wound around the outer peripheral surface side, and when the lens unit 125 is rotated circumferentially in this state, as shown in FIG. 14B, the restricting portions 123 molded integrally with the lens unit 125 are inserted into the recesses 124c formed on the outer peripheral surface side.

This restricts movement of the adjusting screws 124 in the optical axis direction.

Consequently, when an external force is exerted on the lens unit 125 from the subject side in the optical axis direction, the restricting portions 123 molded integrally with lens unit 125 function as stoppers. Therefore, the lens unit 125 is maintained in its position without sinking toward the opposite side from the subject in the optical axis direction.

As a result, the effect is similar to that of the first embodiment described above, namely, that even if an external force is exerted on the lens unit 125 in the optical axis direction, the position of the lens unit 125 in the optical axis direction can be prevented from changing.

(B)

In the above embodiment, an example was given in which the configuration of the present invention was applied to the first lens group unit 11. However, the present disclosure is not limited to this.

For example, the configuration to which the present invention is applied may be a lens frame other than the first lens group unit.

(C)

In the above embodiment, an example was given in which the adjusting screws 24 and the adjustment springs 26 for adjusting the tilt of the lens unit 25 relative to the lens unit holding frame 27 were disposed at three locations at substantially equal angular intervals in the circumferential direction centered on the optical axis, but the present disclosure is not limited to this.

For example, the number of adjusting screws (fastening members) and adjustment springs (biasing members) for adjusting the tilt is not limited to three, and may instead be two, or four or more.

Also, the adjusting screws (fastening members) and adjustment springs (biasing members) for adjusting the tilt may be disposed at intervals other than at substantially equal angular intervals.

(D)

In the above embodiment, an example was given in which adjustment springs formed in a spiral shape were used as biasing members, but the present disclosure is not limited to this.

For example, a configuration featuring some other kind of biasing member, such as a flat spring, may be used.

(E)

In the above embodiment, an example was given in which the anti-sinking members 23 were brought into contact with the screw heads 24b of the adjusting screws 24 to prevent the lens unit 25 from sinking. However, the present disclosure is not limited to this.

For example, the configuration may be such that the lens frame (lens unit) is prevented from sinking by bringing an anti-sinking member into contact with a part of the fastening member (adjusting screw) other than the head.

### NOTES

The above embodiments disclose the following techniques.

### TECHNIQUE 1

The lens barrel according to Technique 1 comprises:

a substantially cylindrical reference frame;

a lens frame that holds a lens and is attached to the reference frame;

a fastening member having a threaded portion that threads into the reference frame, and a screw head provided on an opposite side from the threaded portion, in which the screw head is configured to restrict movement of the lens frame in a direction away from the reference frame in an optical axis direction, and is configured to adjust a tilt of the lens frame relative to the reference frame by changing the threaded length of the threaded portion, and

an anti-sinking member that is fixed to the lens frame and is provided at a position where the anti-sinking member makes contact with part of the fastening member in the optical axis direction.

### TECHNIQUE 2

The lens barrel according to Technique 2 is the lens barrel according to Technique 1,

further comprising a biasing member that is provided between the reference frame and the lens frame and applies a biasing force that biases the lens frame in the optical axis direction relative to the reference frame.

### TECHNIQUE 3

The lens barrel according to Technique 3 is the lens barrel according to Technique 1 or 2,

wherein the lens frame and the anti-sinking member are provided as separate members.

### TECHNIQUE 4

The lens barrel according to Technique 4 is the lens barrel according to any of Techniques 1 to 3,

wherein the anti-sinking member has a hole into which is inserted a jig for adjusting the tilt of the lens frame.

### TECHNIQUE 5

The lens barrel according to Technique 5 is the lens barrel according to Technique 1,

the lens frame and the anti-sinking member are provided integrally as a single unit.

### TECHNIQUE 6

The lens barrel according to Technique 6 is the lens barrel according to Technique 5,

wherein the lens frame has a through-hole into which the fastening member is inserted in the optical axis direction and in which an opening is formed in the circumferential direction, and a restricting portion that is disposed near the through-hole and engages with part of the fastening member when the lens frame rotates in the circumferential direction in a state in which the fastening member has been inserted into the through-hole, thereby restricting movement of the fastening member in the optical axis direction.

### TECHNIQUE 7

The lens barrel according to Technique 7 is the lens barrel according to any of Techniques 1 to 6,

wherein the anti-sinking member is disposed so as to cover the screw head in the optical axis direction.

### TECHNIQUE 8

The lens barrel according to Technique 8 is the lens barrel according to any of Techniques 1 to 7,

wherein the lens frame makes contact with the screw head at the surface on the opposite side from the reference frame in the optical axis direction.

### TECHNIQUE 9

The lens barrel according to Technique 9 is the lens barrel according to any of Technique 2,

wherein the biasing member is a spiral spring member, and

the fastening member is threaded into the reference frame in a state in which the threaded portion has been inserted along the central axis of the biasing member.

### TECHNIQUE 10

The lens barrel according to Technique 10 the present invention is the lens barrel according to any of Technique 2,

wherein a plurality sets of the biasing member and the fastening member are provided in the circumferential direction centered on the optical axis.

### TECHNIQUE 11

The lens barrel according to Technique 11 is the lens barrel according to Technique 10,

wherein a plurality of the biasing members and fastening members are provided at substantially equal angular intervals in the circumferential direction centered on the optical axis.

### INDUSTRIAL APPLICABILITY

The lens barrel disclosed herein exhibits the effect that the position of the lens frame in the optical axis direction is prevented from changing even when an external force is exerted on the lens frame in the optical axis direction, and thus this invention is widely applicable to various types of lens barrel.

### REFERENCE SIGNS LIST

10 lens barrel

11 first lens group unit

12 front frame unit

12a main body portion

12b latched portion

13 cam/rectilinear unit

13a cam follower

13b cam groove

14 second and third lens group unit

14a cam follower

15 exterior unit

15a main body portion

15b focus ring

15c zoom ring

16 rear frame unit

17 lens mount

21 exterior ring

22 fixing screw

23 anti-sinking member

23a hole

24 adjusting screw (fastening member)

24a threaded portion

24b screw head

25 lens unit (lens frame)

26 adjustment spring (biasing member)

27 lens unit holding frame (reference frame)

27a main body portion

27b screw receiving portion

111 first lens group unit

123 restricting portion (anti-sinking member)

124 adjusting screw (fastening member)

124c recess

125 lens unit (lens frame)

125a main body portion

125b through-hole

What is claimed is:

1. A lens barrel, comprising:
a substantially cylindrical reference frame;
a lens frame that holds a lens and is attached to the reference frame;
a fastening member having a threaded portion that threads into the reference frame, and a screw head provided on an opposite side from the threaded portion, in which the screw head is configured to restrict movement of the lens frame in a direction away from the reference frame in an optical axis direction, and is configured to adjust a tilt of the lens frame relative to the reference frame by changing the threaded length of the threaded portion, and
an anti-sinking member that is fixed to the lens frame and is provided at a position where the anti-sinking member makes contact with part of the fastening member in the optical axis direction.

2. The lens barrel according to claim 1,
further comprising a biasing member that is provided between the reference frame and the lens frame and is configured to apply a biasing force that biases the lens frame in the optical axis direction relative to the reference frame.

3. The lens barrel according to claim 1,
wherein the lens frame and the anti-sinking member are provided as separate members.

4. The lens barrel according to claim 1,
wherein the anti-sinking member has a hole into which is inserted a jig for adjusting the tilt of the lens frame.

5. The lens barrel according to claim 1,
wherein the lens frame and the anti-sinking member are provided integrally as a single unit.

6. The lens barrel according to claim 5,
wherein the lens frame has a through-hole into which the fastening member is inserted in the optical axis direction and in which an opening is formed in a circumferential direction, and a restricting portion that is disposed near the through-hole and engages with part of the fastening member when the lens frame rotates in the circumferential direction in a state in which the fastening member has been inserted into the through-hole, thereby restricting movement of the fastening member in the optical axis direction.

7. The lens barrel according to claim 1,
wherein the anti-sinking member is disposed so as to cover the screw head in the optical axis direction.

8. The lens barrel according to claim 1,
wherein the lens frame makes contact with the screw head at a surface on an opposite side from the reference frame in the optical axis direction.

9. The lens barrel according to claim 2,
wherein the biasing member is a spiral spring member, and
the fastening member is threaded into the reference frame in a state in which the threaded portion has been inserted along a central axis of the biasing member.

10. The lens barrel according to claim 2,
wherein a plurality sets of the biasing member and the fastening member are provided in a circumferential direction centered on an optical axis.

11. The lens barrel according to claim 10,
wherein a plurality of the biasing members and fastening members are provided at substantially equal angular intervals in the circumferential direction centered on the optical axis.
